(19) United States
(12) Patent Application Publication
(10) Pub. No.: US 2008/0270784 A1
(43) Pub. Date: Oct. 30, 2008

(54) Display Configuration-Reconfiguration Method For a Set of Display Devices

(75) Inventors: Denis Bonnet, Bordeaux (FR); Bruno Capelle, Bordeaux (FR); Yannick Le Roux, Le Haillan (FR); Francois Michel, Saint Medard En Jalles (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neully Sur Seine (FR)

(21) Appl. No.: 12/089,517

(22) PCT Filed: Oct. 6, 2006
(86) PCT No.: PCT/EP06/67140

§ 371 Date: Apr. 7, 2008

(30) Foreign Application Priority Data
Oct. 7, 2005 (FR) 0510279

(51) Int. Cl. G06F 1/24

(52) U.S. Cl. 713/100

(57) ABSTRACT

The invention relates to systems provide with control devices comprising an important number of displaying devices for displaying an important number of parameters according to accurate configurations, as for example, a modern aircraft instrument panel provided with several displays. The inventive method for configuring or reconfiguring the totality of displaying devices consists in inducing said configuration or reconfiguration by an event. Each elementary configuration is substantially obtainable by means of a reconfiguration logic language and an interpreter algorithm, wherein said logic language substantially comprises a reconfiguration domain, properties, transition rules, and preferences and said interpreter algorithm makes it possible to convert each transition rule into a list of elementary reconfiguration.

### CROSS-REFERENCE TO RELATED APPLICATIONS

The present Application is based on International Application No. PCT/EP2006/067140, filed on Oct. 6, 2006, which in turn corresponds to French Application No. 05 10279 filed on Oct. 7, 2005, and priority is hereby claimed under 35 USC §119 based on these applications. Each of these applications are hereby incorporated by reference in their entirety into the present application.

### FIELD OF THE INVENTION

The field of the invention is that of systems comprising command or control members possessing a significant set of viewing devices having to display a large number of parameters according to precise configurations so that, for example, certain information vital for the operation or safety of the system are always displayed in the most ergonomic manner possible.

The favored field of application is aeronautics. Specifically, the instrument panels of modern aircraft possess at one and the same time a large number of viewing screens that without distinction will be called “VDUs” or else “displays” subsequently in the text and a large number of different displays that will also be called “formats” subsequently in the text.

### DESCRIPTION OF THE PRIOR ART

Thus, the instrument panel of an Airbus A380 possesses 8 main screens and about ten possible configurations per screen. FIG. 1 shows an example of displays in an Airbus A380 cockpit. The 8 VDUs are called respectively L1, L2, L3, C1, C2, R1, R2 and R3. In general, a format is not specific to a particular VDU: it can be displayed successively or simultaneously on several different VDUs. The format termed PFD, the acronym signifying Primary Flight Display, is a format providing the pilot with all the primary flight data such as the altitude or heading. In the example of FIG. 1, the PFD format is displayed at one and the same time by the VDUs L1 and R1. The control panels CPL and CPR depicted in FIG. 2 allow the pilot to intervene so as to select, enter and modify the information displayed.

This invention can however be applied to other technical or industrial fields such as control or command rooms possessing significant sets of viewing devices and requiring a significant reliability and safety level.

In the case of an aircraft instrument panel, it is necessary to be able to easily configure or reconfigure the formats displayed on the VDUs so as:
To ensure the availability of the critical functions, vital for piloting or navigation;
To adapt the configuration of the cockpit to the mission or to the flight phase desired.

Configuration is understood to mean a state of the instrument panel defining the formats displayed on each VDU and reconfiguration is understood to mean a change of state of the instrument panel related to an event.

Currently, the management of configurations-reconfigurations of formats is ensured by a double-input configuration table. The first input gives the events apt to give rise to a reconfiguration and the second input gives the configuration adopted as a function of the event occurring.

This method remains effective so long as the number of events or configurations remains limited. On modern aircraft, the number of possible events has increased significantly. The following may occur:
Equipment faults relating to the VDUs or the onboard computers;
External events such as changes of flight phase or alerts;
Actions of the pilot on the various control members.

Moreover, there exist a large number of displayable images. Thus, a configuration table can comprise more than 10000 unit cells to be filled in.

The management of this table poses several significant problems. It is, of course, very difficult to ensure perfect consistency thereof. Thus, two similar events do not necessarily give analogous configurations, and this may be very disturbing for the pilot in particular in the critical flight phases. Moreover, each change of configuration, though it be minor, will give rise to a complete recasting of the configuration table. It is estimated that several thousands of hours are necessary in the production and checking of a configuration table for a modern aircraft.

Most reconfigurations depend on logic rules which exhibit the advantage of making it possible to synthesize in a consistent manner a large number of possible cases that it would be irksome to enumerate exhaustively.

### SUMMARY OF THE INVENTION

So, the principle of the invention includes replacing the production of the configuration table which is very unwieldy to create and to sustain by a method which, on the basis of these logic rules, automatically generates the desired reconfiguration.

Subsequently in the description, certain words have a precise sense related to the context of the invention. Their definition appears in tandem with the text. These words are the following: place-token-event-property-guard-conclusion-node. The logic operators are enclosed between quotation marks.

More precisely, the subject of the invention is a method of configuring or reconfiguring a plurality of displays called formats on a set of viewing devices called VDUs, the reconfiguration of an initial configuration being prompted by a cause called an event so as to culminate in a final configuration, characterized in that each configuration is obtained essentially by means of a logic reconfiguration language and of an interpretation algorithm, the logic language comprises:
A reconfiguration domain: set of elements comprising mainly:
   places mainly modeling the VDUs;
   tokens mainly modeling the formats;
   the events;
   the logic functions which unite the places, the tokens and the events;
Properties, set of rules defining the acceptable configurations;
Transition rules, set of rules defining the acceptable reconfigurations;
Preferences defining an order of calculation and priority formats on the VDUs;
   and said interpretation algorithm making it possible to transform each transition rule into a list of elementary reconfigurations.

Advantageously, the properties are defined by logic formulae constructed on the basis of the elements of the reconfiguration domain, of comparators and of Boolean operators.

Advantageously, the transition rules are composed of three elements:
An event;
A guard, logic formula which defines the set of initial configurations possible before the event;
A conclusion, logic formula which defines the set of final configurations possible after the event.

Advantageously, the transition rules comprise variables, a variable grouping together a set of places or tokens, certain transition rules are termed imperative, that is to say they must execute without conditions and certain transition rules are termed optional, that is to say they must execute on condition of not violating any property.

Advantageously, the preferences define:
The order of calculation of the places;
The order of preference of the tokens on the places.

Advantageously, the interpretation algorithm comprises a first shaping step called expansion in which:
The logic formulae of the properties are transformed into disjunctive clauses, series of equalities or inequalities between the elements of the reconfiguration domain, separated by the logic operators “or”;
The guards and the conclusions of the transition rules are transformed into conjunctive clauses, series of equalities or inequalities between the elements of the reconfiguration domain, separated by the logic operators “and”, a pair composed of a guard and of a conclusion in the form of two conjunctive clauses being called an initial node, the various initial nodes being stored in a list called the initial list;
The variables are replaced with their values.

Advantageously, the interpretation algorithm comprises a second step of interpreting the initial nodes as final nodes, said second step comprising the following sub-steps:
Creation of a second list of nodes on the basis of the initial list, the nodes of this second list satisfying the following property: if the guard of the node satisfies all the properties of the system, then the conclusion of the node satisfies all the properties of the system;
Creation of a third list of nodes on the basis of the second list, the conclusion of the nodes of this third list no longer possessing any inequalities;
Creation of a final list on the basis of the third list, the guards of the nodes of this final list being exclusive.

Still other objects and advantages of the present invention will become readily apparent to those skilled in the art from the following detailed description, wherein the preferred embodiments of the invention are shown and described, simply by way of illustration of the best mode contemplated by carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents an instrument panel comprising 8 VDUs;

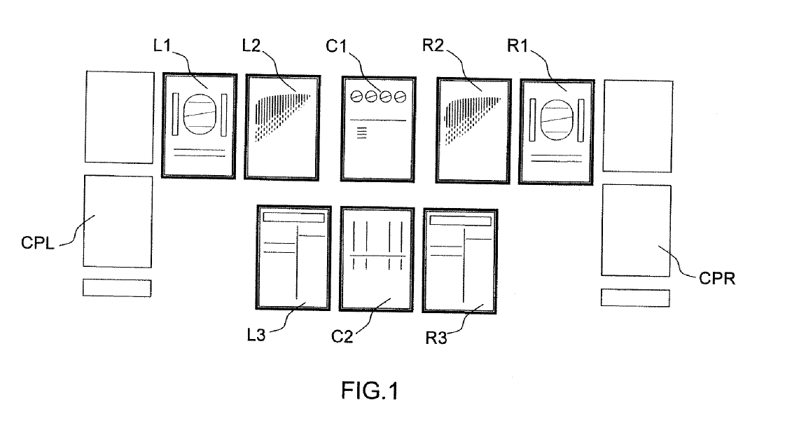

FIG. 2 represents the diagram of the configuration method according to the invention.

### DETAILED DESCRIPTION OF THE INVENTION

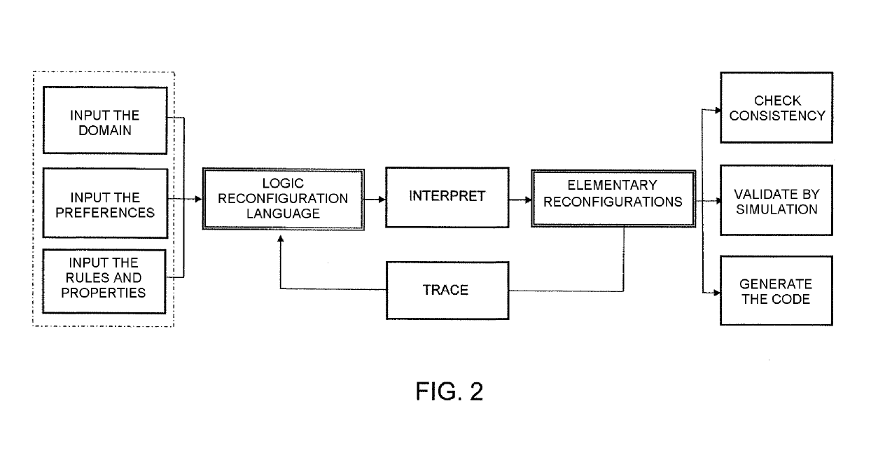

The method according to the invention is shown schematically in FIG. 2. It comprises two large main steps. In a first step, a logic reconfiguration language is defined. In a second step, the elementary configurations are established by means of an interpretation algorithm of this logic language. So, the description which follows also comprises two large parts which are:
The logic reconfiguration language;
The interpretation algorithm.

A third part is devoted to the simulation, to the generation and to the checking of the reconfigurations arising from the interpretation algorithm.

In what follows, all the examples taken relate to the reconfiguration of formats on a set of instrument panel visualizations. The clarity of the text is thus facilitated. Of course, the invention can extend to other applications in other technical or industrial fields while complying with the same principles of formulation of the logic language and of the interpretation algorithm.

### The Logic Reconfiguration Language

The logic language essentially comprises:
A reconfiguration domain, set of elements comprising mainly
   places mainly modeling the VDUs;
   tokens mainly modeling the formats;
   the events;
   the logic functions which unite the places, the tokens and the events;
Properties, set of rules defining the acceptable configurations;
Transition rules, set of rules defining the acceptable reconfigurations;
Preferences defining an order of calculation and priority formats on the VDUs.

This language makes it possible to describe the domain, the properties, the transition rules and the preferences in a synthetic manner. It possesses a formal syntax much like a mathematical language.

The Reconfiguration Domain

The domain makes it possible to define the elements manipulated by the language, mainly, the VDUs, the formats and the events. The reconfigurations can also involve other elements: modes, format backups making it possible to temporarily display a format then to return to the initial format, etc.

The domain consists:
of a set of places which model, for example, the VDUs, the modes, etc.
of a set of tokens which model, for example, the formats, the values of a mode, etc.
of a set of events, each event corresponding to a format display request, a VDU fault, etc.
of a set of logic functions and of relations of the type: “this format has greater priority than that one”

At each instant, a place must possess a single token.

The Properties

The properties make it possible to define the acceptable configurations. They are defined by logic formulae constructed on the basis of the elements of the domain, of comparators and of Boolean operators of the type “and”, “not”, “or”, “implies”, etc.

It is possible to replace the places and the tokens with functions in the logic formulae and to do so in a recursive manner.

The logic formulae are built on the basis of elementary logic formulae and of Boolean operators.

It is also possible to use variables in the logic formulae. They can replace any place or token in a formula. However, the set of values that can be taken by this variable is specified at the start of the formula.

The Transition Rules: Guards and Conclusions

The transition rules define the acceptable reconfigurations, that is to say, the possible evolutions from an initial configuration to a final configuration upon reception of an event. Thus, a transition rule is composed of three elements:
The event which triggers the reconfiguration;
A guard, logic formula which defines the set of initial configurations to which the transition rule is applied,
A conclusion, logic formula which defines the set of possible final configurations following reconfiguration.

There are two types of transition rules:
The imperative transition rules: these transition rules must be executed under all conditions. For example, a VDU fault is an imperative rule: “if a VDU receives a fault event, then it absolutely must turn itself off”.

The rules of optional transition: these rules are satisfied only if the final configuration does not violate any property of the system. For example, if a property of the system is that this or that format must be unique in the cockpit, then the display request for this format will be satisfied only if there is no other identical format already displayed in the cockpit.

Certain transition rules are implicit. This is the case for the rules regarding VDU startup and fault and which must be added automatically during domain definition.

It is also possible to use variables in the logic formulae defining the guard and the conclusion of the rule. However, it is preferable to declare the variables in the header of the transition rather than in each formula, thus it is possible to use variables that are common to the guard and to the conclusion.

The Preferences

The properties and the transition rules limit the possible reconfigurations but do not always suffice to exactly determine the behavior of these reconfigurations. The preferences fill in the voids of the specification.

The preferences are of two types:
The order of calculation of the places;
The order of preference of the tokens on the places.

The order of calculation of the places is a total order on the places of the domain. In the event of impreciseness in a reconfiguration, first the token of the first place is determined in the order of calculation, then the second is determined and so on and so forth up to the last place. For each place, the tokens are ordered in order of preference. In the event of impreciseness in the next token of the place during a reconfiguration, the first token is chosen in the order of preference not contradicting any property of the system.

The Elementary Reconfigurations

The elementary reconfigurations make it possible to calculate the reconfigurations of the system. For a given configuration and an event received, the elementary reconfigurations exactly determine the reconfiguration to be performed.

An elementary reconfiguration is an imperative transition rule. The guard makes it possible to define whether the elementary reconfiguration is applied. If the current configuration satisfies the guard and if the event is received, then the elementary reconfiguration is applied. In this case, the new configuration is calculated by interpreting the equalities of the conclusion as assignments.

The Interpretation Algorithm

The logic reconfiguration language, by itself, is not operative. The function of the interpretation algorithm is to take a transition rule and to transform it into a list of directly applicable elementary reconfigurations.

For this purpose, the interpretation algorithm injects the properties of the system and the preferences into the transition rules by using a resolution algorithm similar to that of the programming language Prolog.

Expansion and Generation of the Clauses

The algorithm requires beforehand a step of shaping, called expansion, the transitions and properties.

The aim of the expansion phase is to simplify the form of the formulae present in the guards and the conclusions of the transitions and in the properties. The formulae in the properties and the transitions are transformed into clauses. The clauses are series of equalities or inequalities separated either:
by “or's”, one then speaks of disjunctive clauses;
by “and's”, one then speaks of conjunctive clauses.

The properties are transformed into disjunctive clauses, that is to say into a series of elementary formulae separated by Boolean operators “or”. For this purpose, the elementary equivalences of the Boolean connectors are used. All the formulae do not necessarily reduce to a single disjunctive clause but a formula can always be put into the form of a series of disjunctive clauses separated by Boolean operators “and”. The algorithm for transforming into disjunctive clauses takes a formula as input and returns the calculated clause. This algorithm stops when it can no longer transform the formula into a single disjunctive clause.

The guards and conclusions formulae are transformed into conjunctive clauses, that is to say into a series of elementary formulae separated by “and's”. For this purpose, the same elementary equivalences as for the disjunctive clauses are used. Just as for the disjunctive clauses, all the formulae do not necessarily reduce to a single conjunctive clause but a formula can always be put into the form of a series of disjunctive clauses separated by Boolean operators “or”.

It is also necessary to substitute in the transitions or the properties, the variables by all the possible values. Thus, for each set of possible values, a transition or a property without variables is obtained.

Following the expansion phase, all the properties of the system are in the form of disjunctive clauses without variables and all the transitions of the system have their guards and their conclusions in the form of conjunctive clauses without variables.

The interpretation algorithm then takes as input a transition resulting from the expansion and outputs a series of elementary reconfigurations.

Nodes and Lists

The interpretation algorithm manipulates nodes. A node is a pair composed of a guard and of a conclusion in the form of two conjunctive clauses separated by “and's”.

The algorithm starts from an initial node originating from a transition and will refine the guard and the conclusion of this node by using the properties and the preferences of the system. This method will produce a set of nodes which will increase in tandem with the refinement.

Concretely, these nodes are stored in a series of lists. Each list guarantees ever stricter properties on the nodes that it contains. The refinement consists in passing the nodes to the lists with the strictest properties. The lists are as follows:
A list ListIn for the input nodes;
A list ListMedium1 whose nodes satisfy the following property: “if the guard satisfies all the properties of the system, then the conclusion satisfies all the properties of the system”;
A list ListMedium2 whose nodes satisfy the property: “The conclusion no longer possesses any inequalities”;
A list ListOut whose nodes satisfy the properties of ListMedium2 and the additional property: “The guards of all the nodes are exclusive”.

The operative process of the algorithm is to conduct the nodes of the list ListIn to the list ListOut while passing through the ListMedium lists. To carry out this operation, the algorithm uses several successive procedures.

The nodes are composed of a pair comprising a guard and a conclusion which are conjunctive clauses separated by “and's”. The sense of a clause and more generally of a formula is given by the set of configurations which satisfies it. When several formulae may be written in a different manner and have the same sense, they are termed equivalent. A set of mutually equivalent formulae is called an equivalence class. For each equivalence class, a normal form is chosen which will represent all the formulae of the class and that subsequently in the text will be denoted between square brackets.

The algorithm must be able to work with the normal forms as with logic formulae.

In conclusion, the nodes manipulated by the algorithm are pairs comprising a [guard] and a [conclusion] where:
[guard] is the normal form of the guard;
[conclusion] is the normal form of the conclusion.

Moreover, the algorithm will associate a set of properties with each of the guards and conclusions. These properties are the properties remaining to be validated for the guard or the conclusion.

For the conclusion, the aim is to decrease this set to the empty set. In this case, the conclusion satisfies all the properties of the system since there is no longer any property still to be validated.

For the guard, the guard is thus specified insofar as the starting configuration satisfies all the properties of the system. The results obtained are thus optimized.

Initialization of the Nodes

The interpretation algorithm comprises a first initialization phase. The initialization takes a transition resulting from the expansion, creates a node with the guard and the conclusion of the transition and puts it in the list ListIn.

On initialization, the set of properties remaining to be validated is associated with the guard and the conclusion. As no operation has been done, the set of these properties is the set of all the properties of the reconfiguration system.

Injection of the Properties

The interpretation algorithm comprises a second phase of so-called property injection.

The aim of this step is to manufacture nodes whose conclusions will satisfy the properties of the system. Certain properties are satisfied from the outset by the conclusion. For all the other properties, it is necessary to refine the conclusions according to a process based on conventional logic resolution identical to that of the Prolog language.

A resolution function is defined which, for a property and a conclusion, eliminates from the property all the (in)equalities incompatible with the conclusion of a node.

There are however cases where more than one (in)equality remains in the property after elimination by the resolution algorithm.

Resolution of the Inequalities.

The interpretation algorithm comprises a third phase of so-called inequality resolution. The aim of this step is to replace all the inequalities by equalities in the conclusions.

In a more precise manner, one seeks to eliminate the inequalities which will give rise to a reconfiguration, that is to say the inequalities which are in the conclusion but not in the guard.

Distinction of the Guards

The interpretation algorithm comprises a fourth phase of so-called guard distinction.

The desire in this step is to prevent, in a given configuration, it being possible to have the choice between two reconfigurations arising from one and the same transition and leading to different final configurations, thus creating an indeterminism.

Formally, the aim of this step is to obtain nodes whose guards are pairwise exclusive. One proceeds by dichotomy. A dichotomy criterion is chosen, the set of guards is divided into two subsets:
the set of guards which satisfies the criterion;
the set of guards which satisfies its converse.

One iterates over the two subsets obtained.

It is beneficial to find at each step the criterion which separates the set of guards into two subsets of nearly equal size. In the implementation, the number of each equality in the guards is calculated and thereafter the number which minimizes the term T is chosen, with:

T=((N/2−N₁)²−(N/2−N₂)²)

Where N is the total number of nodes, N₁ is the number of nodes satisfying the guard and N₂ is the number of nodes not satisfying the guard.

The algorithm stops when no more criteria capable of splitting the set into two are found. At this juncture, this signifies that all the nodes have an identical guard with different conclusions.

It is possible to choose a conclusion from among the various conclusions. However, certain configurations satisfying the guard can have a preferable reconfiguration or a preferable conclusion. The preference criteria depend essentially on the number of VDUs to be reconfigured that one wishes to minimize and on the order of preference of the formats.

In this case, the set of guards continues to be split not so as to distinguish the guards but to obtain guards whose configurations have a single preferable conclusion.

Shaping

The shaping consists in transforming all the nodes of the list ListOut into elementary reconfigurations:
the event is that of the transition input to the algorithm
the guard and the conclusion are chosen from among those belonging to the equivalence class represented by the normal form

On completion of the shaping, a set of elementary reconfigurations is obtained for each transition obtained following the expansion. These elementary reconfigurations possess the following properties:
The elementary reconfigurations preserve the properties of the system. If C is an initial configuration satisfying all the properties of the system and if C′ is a final configuration obtained following an elementary reconfiguration, then C′ satisfies all the properties of the system.
The elementary reconfigurations have their guard pairwise exclusive. It is not possible to apply two reconfigurations arising from one and the same transition arising from the expansion.
The elementary reconfigurations comply with the transitions. E being an event, if (C,e,C′) is a reconfiguration obtained by applying an elementary reconfiguration, then it is an acceptable reconfiguration for the transition rule from which the elementary reconfiguration arises.

However, the interpretation algorithm has a certain number of limits:
The interpretation algorithm guarantees only that the guards are pairwise disjoint for a transition arising from the expansion. It does not guarantee that the guards are disjoint for elementary reconfigurations arising from two different transitions or else from a transition with different variable values;
The interpretation algorithm does not guarantee the completeness of the transition rules. In certain cases, it is not possible to perform the reconfiguration since the final configuration does not satisfy the properties of the system. For a transition of imperative type, it is necessary to check that, for any configuration, if this transition rule is applied to the configuration, then there exists an elementary reconfiguration arising from the transition rule which is also applied to the configuration.

So, verificatory checks must be made.

Checks, Generation of the Reconfigurations and Simulation.

Checks

The checks make it possible to check that the set of elementary reconfiguration rules is a system having the following characteristics:
It is operational. For a given configuration and an event, it must make it possible to calculate the reconfiguration to be performed;
It is deterministic. For a given configuration and an event, several possible reconfigurations do not exist.
It is complete with respect to the transition rules. For a transition of imperative type, it checks that certain reconfigurations are not lost by using the elementary reconfigurations. More formally, for any configuration, if a transition rule is applied to the configuration, then there exists an elementary reconfiguration arising from the transition rule which is also applied to the configuration.
It preserves the properties. The elementary reconfigurations cannot produce any configuration not satisfying the properties of the system.

These checks pertain to the elementary reconfigurations. Other checks must also be undertaken on the logic language. They relate essentially to the consistency of the properties, the set of properties of the system having not to be contradictory. More simply, there must exist at least one configuration satisfying all the properties of the system.

The system is automatically operational by construction.

Concerning the determinism of the system, it is necessary to check that several possible reconfigurations do not exist for a given configuration. Formally, it suffices to ensure that the guards of the elementary reconfigurations for a given event are pairwise disjoint. It is known that the interpretation algorithm guarantees that two elementary reconfigurations arising from a transition where all the variables have been evaluated have disjoint guards. Therefore, errors are present if:
Two transition rules exist with non-disjoint guards
A transition rule exists with variables which give non-disjoint guards for two possible evaluations of the variables.

In both cases, it is necessary to rewrite the transition rules to correct these errors.

So that completeness is satisfied, it is necessary that an imperative transition and the set of elementary reconfigurations arising from said transition be applied to the same set of configurations.

Conservation of the properties is covered by the interpretation algorithm in the following manner. If configuration before reconfiguration is acceptable, it then satisfies all the properties of the system, then configuration after reconfiguration is also acceptable, it also satisfies all the properties of the system. It suffices to check that the configuration or configurations on initialization of the system satisfy all the properties of the system. At the same time, the consistency of the properties is guaranteed since there exists at least one configuration, the initial configuration which satisfies all the properties of the system.

It is also necessary to check that a given configuration is acceptable, that is to say that it satisfies all the properties of the system.

Code Generation

Simulation and code generation rely on a basic process executed in a loop which, given an initial configuration and a received event, calculates the next configuration. It can be put into the form of a function which calculates the next configuration on the basis of a configuration and an event.

The calculation of the next reconfiguration searches for the elementary reconfiguration whose guard is satisfied by the initial configuration, then applies the conclusion of the elementary reconfiguration to the initial configuration to obtain the final configuration.

Code generation involves a large number of possible solutions. For example, it is possible to write a generic reconfiguration function once and for all. The role of this function is to elect the elementary reconfiguration and to apply it. For this purpose, it uses the elementary reconfigurations generated either in the form of arrays or elementary data, or else in the form of codes.

Simulation and Traceability

Simulation makes it possible to validate the input specification. For each reconfiguration it is therefore important to determine the properties, the preferences and the transition rules which served to calculate the reconfiguration. To this end, a traceability function is used which, with each elementary reconfiguration, associates the transition rule, the properties and the preferences which have allowed its calculation.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method of configuring and reconfiguring a plurality of display formats on a set of viewing devices (VDUs), the reconfiguration of an initial configuration being prompted by an event so as to culminate in a final configuration, wherein each configuration is obtained by means of a logic reconfiguration language and of an interpretation algorithm, said logic language comprising:
a reconfiguration domain including a set of elements comprising
places modeling the VDUs;
tokens modeling the formats;
the events;
the logic functions which unite the places, the tokens and the events;
properties including a set of rules defining acceptable configurations;
transition rules including a set of rules defining acceptable reconfigurations;
preferences defining an order of calculation and priority formats on the VDUs;
and said interpretation algorithm for transforming each transition rule into a list of final reconfigurations.

2. The method as claimed in claim 1, wherein the properties are defined by logic formulae constructed on the basis of the elements of the reconfiguration domain, of comparators and of Boolean operators.

3. The method as claimed in claim 1, wherein the transition rules are composed of three elements:
an event;
a guard including a logic formula which defines the set of initial configurations possible before the event;
a conclusion including a logic formula which defines the set of final configurations possible after the event.

4. The method as claimed in claim 1, wherein the transition rules comprise variables and a variable grouping together form a set of places or tokens.

5. The method as claimed in claim 3, wherein certain transition rules are termed imperative, that is to say they must execute without conditions.

6. The method as claimed in claim 3, wherein certain transition rules are termed optional, that is to say they must execute on condition of not violating any property.

7. The method as claimed in claim 1, wherein the preferences define:
the order of calculation of the places;
the order of preference of the tokens on the places.

8. The method as claimed in claim 1, wherein the interpretation algorithm comprises a first shaping step called expansion in which:
the logic formulae of the properties are transformed into disjunctive clauses, series of equalities or inequalities between the elements of the reconfiguration domain, separated by the logic operators “or”;
the guards and the conclusions of the transition rules are transformed into conjunctive clauses, series of equalities or inequalities between the elements of the reconfiguration domain, separated by the logic operators “and”, a pair composed of a guard and of a conclusion in the form of two conjunctive clauses being called an initial node, the various initial nodes being stored in a list called the initial list;
the variables are replaced with their values.

9. The method as claimed in claim 8, wherein the interpretation algorithm comprises a second step of interpreting the initial nodes as final nodes, said second step comprising the following sub-steps:
creation of a second list of nodes on the basis of the initial list, the nodes of this second list satisfying the following property: if the guard of the node satisfies all the properties of the system, then the conclusion of the node satisfies all the properties of the system;
creation of a third list of nodes on the basis of the second list, the conclusion of the nodes of this third list no longer possessing any inequalities;
creation of a final list on the basis of the third list, the guards of the nodes of this final list being exclusive.

10. The method as claimed in claim 2, wherein the interpretation algorithm comprises a first shaping step called expansion in which:
the logic formulae of the properties are transformed into disjunctive clauses, series of equalities or inequalities between the elements of the reconfiguration domain, separated by the logic operators “or”;
the guards and the conclusions of the transition rules are transformed into conjunctive clauses, series of equalities or inequalities between the elements of the reconfiguration domain, separated by the logic operators “and”, a pair composed of a guard and of a conclusion in the form of two conjunctive clauses being called an initial node, the various initial nodes being stored in a list called the initial list;
the variables are replaced with their values.

11. The method as claimed in claim 3, wherein the interpretation algorithm comprises a first shaping step called expansion in which:
the logic formulae of the properties are transformed into disjunctive clauses, series of equalities or inequalities between the elements of the reconfiguration domain, separated by the logic operators “or”;
the guards and the conclusions of the transition rules are transformed into conjunctive clauses, series of equalities or inequalities between the elements of the reconfiguration domain, separated by the logic operators “and”, a pair composed of a guard and of a conclusion in the form of two conjunctive clauses being called an initial node, the various initial nodes being stored in a list called the initial list;
the variables are replaced with their values.

12. The method as claimed in claim 4, wherein the interpretation algorithm comprises a first shaping step called expansion in which:
the logic formulae of the properties are transformed into disjunctive clauses, series of equalities or inequalities between the elements of the reconfiguration domain, separated by the logic operators “or”;
the guards and the conclusions of the transition rules are transformed into conjunctive clauses, series of equalities or inequalities between the elements of the reconfiguration domain, separated by the logic operators “and”, a pair composed of a guard and of a conclusion in the form of two conjunctive clauses being called an initial node, the various initial nodes being stored in a list called the initial list;
the variables are replaced with their values.

13. The method as claimed in claim 5, wherein the interpretation algorithm comprises a first shaping step called expansion in which:
the logic formulae of the properties are transformed into disjunctive clauses, series of equalities or inequalities between the elements of the reconfiguration domain, separated by the logic operators “or”;
the guards and the conclusions of the transition rules are transformed into conjunctive clauses, series of equalities or inequalities between the elements of the reconfiguration domain, separated by the logic operators “and”, a pair composed of a guard and of a conclusion in the form of two conjunctive clauses being called an initial node, the various initial nodes being stored in a list called the initial list;
the variables are replaced with their values.

14. The method as claimed in claim 6, wherein the interpretation algorithm comprises a first shaping step called expansion in which:
the logic formulae of the properties are transformed into disjunctive clauses, series of equalities or inequalities between the elements of the reconfiguration domain, separated by the logic operators “or”;
the guards and the conclusions of the transition rules are transformed into conjunctive clauses, series of equalities or inequalities between the elements of the reconfiguration domain, separated by the logic operators “and”, a pair composed of a guard and of a conclusion in the form of two conjunctive clauses being called an initial node, the various initial nodes being stored in a list called the initial list;
the variables are replaced with their values.

15. The method as claimed in claim 10, wherein the interpretation algorithm comprises a second step of interpreting the initial nodes as final nodes, said second step comprising the following sub-steps:
creation of a second list of nodes on the basis of the initial list, the nodes of this second list satisfying the following property: if the guard of the node satisfies all the properties of the system, then the conclusion of the node satisfies all the properties of the system;
creation of a third list of nodes on the basis of the second list, the conclusion of the nodes of this third list no longer possessing any inequalities;
creation of a final list on the basis of the third list, the guards of the nodes of this final list being exclusive.

16. The method as claimed in claim 11, wherein the interpretation algorithm comprises a second step of interpreting the initial nodes as final nodes, said second step comprising the following sub-steps:
creation of a second list of nodes on the basis of the initial list, the nodes of this second list satisfying the following property: if the guard of the node satisfies all the properties of the system, then the conclusion of the node satisfies all the properties of the system;
creation of a third list of nodes on the basis of the second list, the conclusion of the nodes of this third list no longer possessing any inequalities;
creation of a final list on the basis of the third list, the guards of the nodes of this final list being exclusive.

17. The method as claimed in claim 12, wherein the interpretation algorithm comprises a second step of interpreting the initial nodes as final nodes, said second step comprising the following sub-steps:
creation of a second list of nodes on the basis of the initial list, the nodes of this second list satisfying the following property: if the guard of the node satisfies all the properties of the system, then the conclusion of the node satisfies all the properties of the system;
creation of a third list of nodes on the basis of the second list, the conclusion of the nodes of this third list no longer possessing any inequalities;
creation of a final list on the basis of the third list, the guards of the nodes of this final list being exclusive.

18. The method as claimed in claim 13, wherein the interpretation algorithm comprises a second step of interpreting the initial nodes as final nodes, said second step comprising the following sub-steps:
creation of a second list of nodes on the basis of the initial list, the nodes of this second list satisfying the following property: if the guard of the node satisfies all the properties of the system, then the conclusion of the node satisfies all the properties of the system;
creation of a third list of nodes on the basis of the second list, the conclusion of the nodes of this third list no longer possessing any inequalities;
creation of a final list on the basis of the third list, the guards of the nodes of this final list being exclusive.

19. The method as claimed in claim 14, wherein the interpretation algorithm comprises a second step of interpreting the initial nodes as final nodes, said second step comprising the following sub-steps:
creation of a second list of nodes on the basis of the initial list, the nodes of this second list satisfying the following property: if the guard of the node satisfies all the properties of the system, then the conclusion of the node satisfies all the properties of the system;
creation of a third list of nodes on the basis of the second list, the conclusion of the nodes of this third list no longer possessing any inequalities;
creation of a final list on the basis of the third list, the guards of the nodes of this final list being exclusive.
